(19) United States
(12) Patent Application Publication
(10) Pub. No.: US 2007/0253531 A1
(43) Pub. Date: Nov. 1, 2007

(54) Radiographic image reading apparatus and diagnosis system

(76) Inventors: Jiro Okuzawa, Tokyo (JP); Mamoru Umeki, Tokyo (JP); Wataru Motoki, Tokyo (JP)

Correspondence Address: CANTOR COLBURN, LLP, 55 GRIFFIN ROAD SOUTH, BLOOMFIELD, CT, 06002, US

(21) Appl. No.: 11/729,143

(22) Filed: Mar. 28, 2007

(30) Foreign Application Priority Data
Apr. 3, 2006 (JP) JP2006-101985
Apr. 5, 2006 (JP) JP2006-104346

(51) Int. Cl. G01N 23/04

(52) U.S. Cl. 378/62

(57) ABSTRACT

According to a reading apparatus relating to the present invention, when keys of a ten-key pad of an operation section are pressed and a search ID is inputted, body part icon is displayed on a display section. When one part is selected from the displayed body part icon and a cassette is set, radiographic image recorded on a stimulable phosphor plate built in the cassette is read by an image generating section, and image data are generated at a sampling pitch predetermined according to the imaging part, and image processes such as an ROI extraction process and a gradation process are performed for the generated image data according to the imaging part. The processed image data, after information of the imaging part is written into a header portion, is transmitted to a control apparatus by a communication section.

This application is based on Japanese Patent Applications No. 2006-101985 filed on Apr. 3, 2006 and No. 2006-104346 filed on Apr. 5, 2006 in Japanese Patent Office, the entire content of which is hereby incorporated by reference.

### BACKGROUND OF THE INVENTION

The present invention relates to a radiographic image reading apparatus and a diagnosis system, which will be mainly used for a small-scale diagnosis system at small-scale medical facilities.

There has been known a diagnosis system, in which a technician uses an image generating apparatus, such as a CR (Computed Radiography) apparatus, FPD (Flat Panel Detector) apparatus and the same to photograph a subject patient, who has visited a medical facility, applies an image processing, such as a gradation processing, onto the obtained images and operates to output the images, to which the image processing has been applied, so that a medical doctor can analyze the medical images.

With respect to the diagnosis system, a plurality of persons in charge play respective roles to proceed the diagnosis as following. A receptionist receives a patient, who has visited the medical facility, and issues an examination order (a receptionist); A technician actually radiographs the patient in the radiographing room and forms digital image data; A technician (who has been selected from general technicians) or the same determines whether or not the gradation of the image is capable of being used for diagnosis and corrects the contrast and density of the image if necessary; And a person in charge of analyzing (a medical doctor) determines whether or not there is an illness based on the image.

In large-scale medical facilities (they will be called large-scale facilities hereinafter) in which conventional diagnosis systems are supposed to be used, there exist a plurality of image generating apparatuses and a plurality of technicians for operating the image generating apparatuses, and there are separately provided a console for operating the image generating apparatus for the plurality of technicians and a viewer by which the medical doctor checks the image data, as sharing respective roles. Thus, there has been a possibility that the patient mismatches with his or her image data by mistake. Accordingly, in order to prevent this, a system for connecting respective apparatuses through network, issuing ID at respective apparatuses and correlating the results of work processes of the respective apparatuses with each other is proposed (for example, see Patent Document 1).

With respect to the location for playing the roles described above in these systems, in many hospitals; a reception desk and a radiology department are separately and remotely located. For example, the reception desk is located in the first floor and the radiology department is located in the basement. Further, it is common that a plurality of technicians use a plurality of radiographing apparatuses to simultaneously execute radiographing and a plurality of patients constantly exist at respective processes. In order to prevent the mistake occurring in the correlation of the formed image with the patient, methods for adding ID onto works of respective process and correlating respective works with each other via a network of HIS (Hospital Information System) and RIS (Radiology Information System) are conducted (for example, see Patent Documents 2 and 3).

For example, at the reception desk located in the first floor, examination items (photographing items) are determined based on interview of a patient and the examination items are registered together with the patient name. Based on this action, a patient list shown in FIG. 10(a) is generated. Additional patient information will be added to the list whenever it is necessary, and the patient list will be displayed on the workstation (it will be called “WS” hereinafter), which is set on the reception desk located in the first floor. Simultaneously, the patient list described above is displayed on the console located in the radiography department located in B1 (basement) via network of RIS/HIS. (Here, a “console” denotes a workstation for displaying the settings of radiography condition, examination order information of RIS/HIS and images obtained by radiographing the patient. It is common that the total number of the consoles is plural in order to improve the decentrized processing efficiency. These consoles are connected each other via network. When a predetermined ID has been selected at a console out of the consoles, in order to avoid duplicated radiographing in the plurality of technicians, a method for making the patient list to notify that the examination is under process is utilized (for example, flashing display, changing the color of the patient list or outputting beep sound when the same inspection is specified).

According to the system in these large-scale facilities, the technician of the radiography department selects the examination ID to be radiographed from now on in the displayed patient lists by using the console located near the technician, and registers the ID (the cassette ID) of a CR plate (cassette) to be used for the photographing. Based on this action, the registered cassette ID is displayed in the cassette ID column of the patient list as shown in FIG. 10(b). The technician, for example, brings three cassettes with him or her and moves to a radiographing room to take X-ray images of the patient. After that the cassette, onto which X-ray images have been recorded, is read by a reading apparatus. The reading apparatus reads the cassette ID adhered onto the cassette, which has been inserted therein, transmits the cassette ID together with image data and finally correlates the examination ID (a patient ID) with the generated image data. The generated image data is transmitted to the console, by which the technician had selected the examination ID, and is displayed on the console. At this step, the technician checks the X-ray image positioning, conducts radiographing again when the positioning is not appropriate, and determines whether or not the density and contrast corrections and a frequency emphasis process should be applied. After that the generated image data is stored in an analysis-waiting (diagnosis-waiting) server. A medical doctor for analyzing images analyzes the image (conducts diagnosis) by selecting and displaying the image related to a predetermined patient out of images, which have been stored in the analysis-waiting server on the workstation in a diagnosis room (many of the workstations have a high definition monitor for the viewer function).

In the system utilized in a large-scale facility described above, with respect to the information affecting medical insurance point calculation, such as whether or not the radiographing conducted for the patient is simple radiographing or radipgraphing using a contrast agent (medium), the system is arranged to be able to consolidate the all information items into RIS/HIS sever for controlling by registering the examination ID of the patient, the cassette ID, and correlating the captured images to the patient.

However, according to the survey conducted by the inventors of this invention, in the case of relatively small-scale medical facilities (it will be called small-scale facilities hereinafter) such as a small medical clinic, in many cases, the image generating apparatus installed are not many. Further, in many cases, an assistant to the medical doctor conducts positioning of the patient when radiographing, and the medical doctor controls the emitting switch of X-ray after the assistant informs of the completion of positioning or a medical doctor conducts all operations including the positioning of the patient.

Further, for example, in the case of large-scale facilities, it is presumed that a patient has to move around plural floors in the facilities in the time duration from the time of radiographing to the time when a medical doctor starts diagnosis of the patient. However, in the case of small facilities, since the facility is narrow, the moving distance of the patient in the time duration from the time radiographing to the time when the medical doctor starts diagnosis of the patient is short.

Under these conditions, it is hard to imagine that the photographed image is regarded as an image of other patient. Consequently, when the same system as the system used in the large-scale system is used in the small-scale facilities, since it is necessary to generate examination order information starting from the input operation of the patient name, the procedure becomes complicated and the diagnosis efficiency becomes worse.

Further, in order to generate the examination order information including patient information and examination information of the patient in advance and to correlate the examination order information with the photographed image, which has been radiographed, a system, to which respective apparatuses are connected via network corresponding to the main system, such as HIS/RIS, becomes necessary. However, in order to configure this type of system described above, a certain level of cost is necessary, which becomes a problem for a small-scale facility. Further it is not optimum to introduce the same system utilized in the large-scale facilities described above into a small-scale facilities, even though leaving the same configuration concept with decreased number of apparatuses.

Therefore, in Patent Document 4, as a system for a small-scale facility such as a small medical clinic, a system is described including an information input/output unit arranged in a diagnosis room and a radiographic image information reading apparatus in an imaging room, which are connected via a network, for transmitting ID information and photographing information of a patient inputted from the information input/output unit by a doctor to the radiographic image reading apparatus and displaying the ID information and photographing information of the patient, who is an imaging object, on a display section of the radiographic image reading apparatus.

Patent Document 1: U.S. Pat. No. 5,334,851

Patent Document 2: Unexamined Japanese Patent Application Publication No. 2002-159476

Patent Document 3: Unexamined Japanese Patent Application Publication No. 2002-311524

Patent Document 4: Unexamined Japanese Patent Application Publication No. 2005-265943

However, even in the system described in Patent Document 4, for the doctor before starting photographing, work of inputting the ID information and photographing information, that is, the patient information and information on the imaging part and others is still necessary and in a small-scale facility without possibility of taking a photographed image for different person from the patient, the diagnostic efficiency is bad. On the other hand, for the image data of the photographed image read by the radiographic image reading apparatus, the image processes such as a gradation process are performed so as to obtain an image quality suited to diagnosis. However, these image processes are different in the programs and parameters used for the processes depending on the imaging part, so that if examination order information is not inputted beforehand, an apparatus for performing the image processes must perform firstly the process of analyzing an image and recognizing the image part, thus a problem arises that it takes long time for the image processes.

Further, in such a small-scale facility, unlike a large-scale facility, the imaging executed is mostly typical and a situation of mistaking photographing conditions (for example, excessive irradiation of X rays such as causing saturation of reading signals is executed or irradiation of X rays not reaching a necessary dose is executed) is inconceivable. Therefore, if only the positioning is correct, by performing digital image processing for an image, the image can be mostly used for diagnosis.

Therefore, if suitability of the positioning is judged earlier and necessity of re-photographing can be decided, the imaging efficiency can be enhanced and the labor of a patient of moving in the facility for re-photographing can be saved. However, according to the conventional system corresponding to a large-scale facility, the positioning is confirmed after image data is transmitted to a console, so that an imaging operator (an imaging engineer or a doctor) must go to confirm the suitability of positioning in photographing to the transmission destination of the image data and the patient must return to the imaging room for re-photographing, when the imaging is not appropriate, thus useless labor is required and a problem arises that the imaging efficiency is bad.

### SUMMARY

Therefore, the present invention was developed to solve the aforementioned problems and is intended to improve the processing efficiency and diagnostic efficiency in a small-scale facility.

To solve the aforementioned problems, the embodiments are as indicated below.

(1) A radiographic image reading apparatus used for a small-scale diagnostic system for executing radiographing of a patient using a cassette having a built-in stimulable phosphor plate, reading radiographic image information of the patient recorded in the stimulable phosphor plate built in the cassette by the radiographic image reading apparatus, thereby generating a photographed image, and then correlating the generated photographed image with patient information of the patient, including:

a display device for displaying a body part icon indicating the respective parts of the human body on the display screen,

a selection device for selecting and inputting one part corresponding to the imaging part of the patient from the displayed body part icon,

a reading device for reading the radiographic image information of the patient recorded on the stimulable phosphor plate built in the cassette and obtaining a photographed image, and

a processing device for processing the photographed image read by the reading device on the basis of the part selected by the selection device.

(2) A diagnostic system including a radiographic image reading apparatus for executing radiographing of a patient using a cassette having a built-in stimulable phosphor plate, reading radiographic image information of the patient recorded in the stimulable phosphor plate built in the cassette by the radiographic image reading apparatus, thereby generating a photographed image, and then correlating the generated photographed image with patient information of the patient, including:

a display device for displaying a body part icon indicating the respective parts of the human body on the display screen,

a selection device for selecting and inputting one part corresponding to the imaging part of the patient from the displayed body part icon,

a reading device for reading the radiographic image information of the patient recorded on the stimulable phosphor plate built in the cassette and obtaining a photographed image, and

a processing device for processing the photographed image read by the reading device on the basis of the part selected by the selection device

and the diagnostic system further including a control apparatus, wherein:

the reading apparatus further includes:

a transmission instruction input device for inputting a transmission instruction for transmitting the photographed image data to the control apparatus and

a transmitting device for transmitting the photographed image data to the control apparatus according to the transmission instruction from the transmission instruction input device and

the control apparatus includes:

a receiving device for receiving the photographed image data transmitted by the transmitting device and

a correlating device for correlating the photographed image data received by the receiving device to the patient information concerning the patient corresponding to the photographed image data.

### BRIEF DESCRIPTION OF THE DRAWINGS

FIG. 1 is a drawing showing a whole constitution example of a small-scale diagnostic system 1 relating to the present invention.

FIG. 2 is a drawing showing an arrangement example in a medical facility of the apparatuses when the small-scale diagnostic system 1 shown in FIG. 1 is applied.

FIG. 3 is a perspective view showing the schematic constitution of a reading apparatus applied to the diagnostic system shown in FIG. 1.

FIG. 4 is a block diagram of the essential section showing the functional constitution of a reading apparatus 202 applied to the small-scale diagnostic system 1 shown in FIG. 1.

FIG. 5 is a drawing showing one display example of the operation/display section of the reading apparatus shown in FIG. 3.

FIG. 6 is a block diagram of the essential section showing the functional constitution of a control apparatus 3 applied to the small-scale diagnostic system 1 shown in FIG. 1.

FIG. 7 is a flow chart showing the detailed flow of the generation process of photographed image data of a patient executed by the reading apparatus 202 and control apparatus 3 shown in FIG. 2 and the correlating process of the photographed image data to the patient.

FIG. 8 is a drawing showing an example of the human body part icon displayed on a display section 221 shown in FIG. 4.

FIG. 9 is a drawing showing an example of a photographed image display screen 351 displayed on a display section 35 shown in FIG. 6.

FIG. 10(a) is a drawing showing an example of a list registered at the reception of the conventional diagnostic system and FIG. 10(b) is a drawing showing an example when an engineer of the radiation department registers a cassette in the list shown in FIG. 10(a) in the conventional diagnostic system.

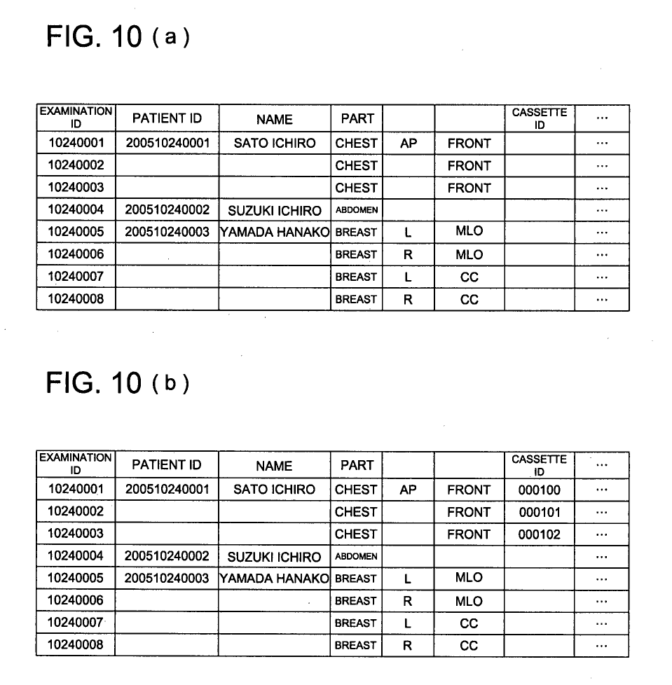

FIG. 11 is a drawing showing a data storage example of the reception DB shown in FIG. 1.

### DETAILED DESCRIPTION OF THE PREFERRED EMBODIMENT

Furthermore, in another embodiment, the processing device, according to the part selected by the selection device, performs the image processing including at least one of the ROI extraction process and gradation process for the photographed image.

Furthermore, in still another embodiment, the processing device performs a process of writing information of the part selected by the selection device in the supplementary information of the photographed image.

Furthermore, in a further embodiment, on the display screen of the display device, touch panel is overlaid and the selection device is composed of the human body part icon displayed on the display device and the touch panel.

Furthermore, in a still further embodiment, a reading apparatus and a diagnostic system for earlier confirming suitability of the positioning and efficiently photographing a patient are provided.

Namely, the reading apparatus is a reading apparatus for executing radiographing for a patient, thereby reading radiographic image information from the stimulable phosphor plate recording the radiographic image information, thereby generating photographed image data, including:

an image generating device for reading the radiographic image information of the patient recorded on the stimulable phosphor plate and generating photographed image data,

a reduced image generating device for generating reduced image data on the basis of the photographed image data generated by the image generating device, and

a display device for displaying the reduced image on the basis of the reduced image data generated by the reduced image generating device.

Furthermore, in a still further embodiment, a diagnostic system includes the abovementioned reading apparatus and a control apparatus and

the reading apparatus further includes:

a transmission instruction input device for inputting a transmission instruction for transmitting the photographed image data to the control apparatus and

a transmitting device for transmitting the photographed image data to the control apparatus according to the transmission instruction from the transmission instruction input device and
the control apparatus includes:

a receiving device for receiving the photographed image data transmitted by the transmitting device and

a correlating device for correlating the photographed image data received by the receiving device to the patient information concerning the patient corresponding to the photographed image data.

Furthermore, in yet a further embodiment, in the diagnostic system aforementioned, in the display device of the reading apparatus, the touch panel is overlaid and the transmission instruction input device is composed of the display device and the touch panel.

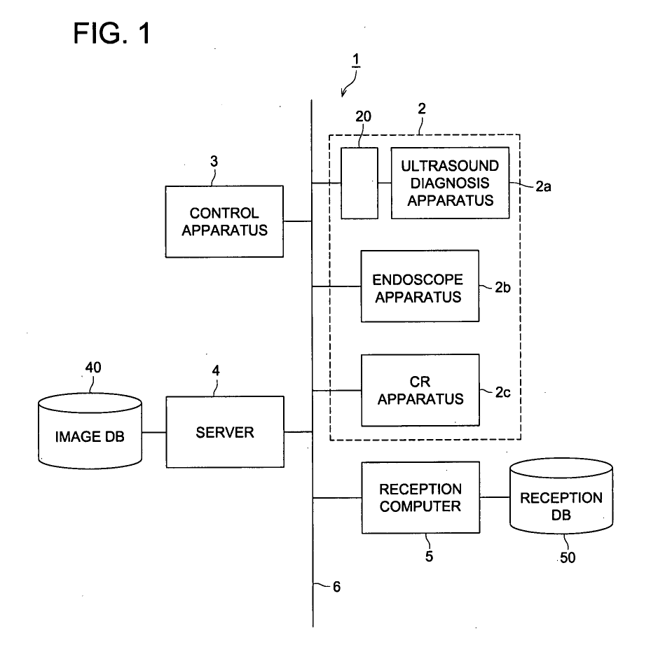

An embodiment of a small-scale diagnosis system of the present invention will be described by referring to FIGS. 1-9 and 11 hereinafter. However, the present invention is not limited to the examples illustrated in the figures.

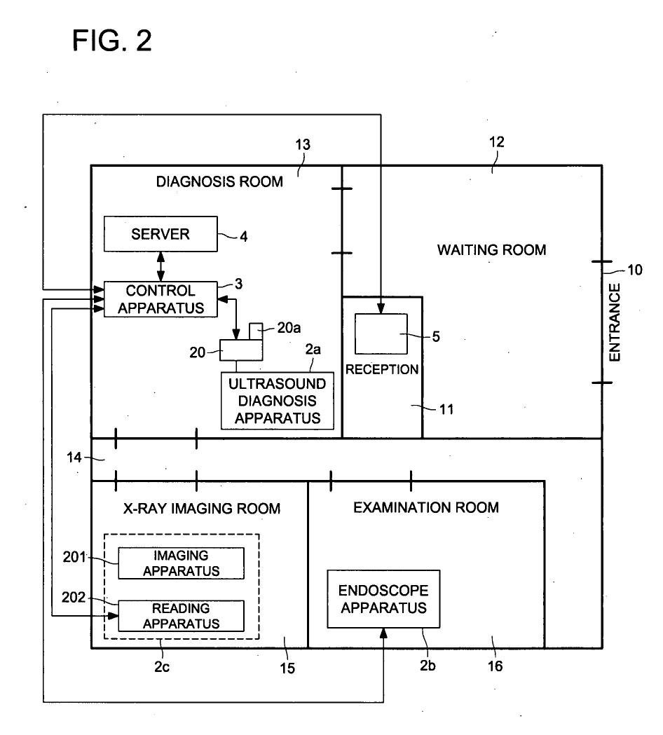

FIG. 1 illustrates a system configuration of an embodiment of the small-scale diagnosis system 1 of the present invention. FIG. 2 illustrates an example of the arrangement of respective apparatuses in a medical facility, to which the small-scale diagnosis system shown in FIG. 1 is applied.

A diagnosis system 1 is a system applied to a comparatively small-scale medical facility, such as a small medical clinic. As shown in FIG. 1, the diagnosis system 1 comprises an image generating apparatus 2 for generating image data of image data of a photographed image (photographed image data), including an ultrasound diagnosis apparatus 2a, an endoscope apparatus 2b and an CR (Computed Radiography) apparatus 2c, a control apparatus 3 as a control device, a server 4 and a reception computer 5. Respective apparatuses are connected to communication network 6 (it will be simply called “network” hereinafter) such as LAN (Local Area Network) via, for example, a switching hub (not shown). Further, the number of each apparatus in the diagnostic system 1 is not restricted particularly, however from the viewpoint of condensing control of the whole system at one location and saving the labor of movement of an operator, only one control apparatus 3 is preferably installed in the diagnostic system 1.

With respect to the communication system in a hospital, in general, DICOM (Digital Image and Communications in Medicine) standard protocol is used. The communication system, which can be applied to the embodiment of the present invention is not limited to these communication systems described above.

For example, in a small-scale medical facility, such as a small medical clinic, respective apparatuses are arranged as shown in FIG. 2.

Namely, when entering an entrance 10, a reception desk 11 for receiving patients and a waiting room 12 are provided. A receptionist is disposed at the reception desk 11 and when the patients check in at the reception desk 11, the receptionist gives a reception number (order of reception with a serial number of the day), which is the order of the check-in, to the patients. At this time, for example, a reception number plate (reception sheet or patient registration card) or the like, onto which a reception number has been printed may be issued from a card issuing apparatus which is not illustrated. The reception computer 5, which is used for the reception, insurance point calculation and accounting calculation, is provided at the reception desk 11. The receptionist obtains the name of a patient when a patient checks in, and inputs the reception number correlated with the name of the patient through the reception computer 5. Further, the receptionist also inputs necessary item for the information related to the insurance point calculation (it will be called “reception related information” hereinafter) based on the patient medical record of the patient after completing medical examination of the patient.

Next to the waiting room 12, a diagnosis room 13 where a medical doctor conducts a medical examination and diagnosis, which is isolated by a door and the same, is provided. For example, a control apparatus 3, by which the medical doctor inputs patient information (patient information such as patient name, birth date) or checks a captured image displayed on a viewer, and a server 4 including an image DB (database) 40, as a storing device into which various types of information such as image data of taken images are stored, are arranged on the diagnosis desk (not shown) in the diagnosis room 13. Since from the viewpoint of privacy, the necessity of conducting an ultrasound diagnosis in an isolated place is low, an ultrasound diagnosis apparatus 2a is also provided in the diagnosis room 13.

An X-ray imaging room 15 for conducting X-ray imaging is provided across a passageway 14, which is facing to the diagnosis room 13. In the X-ray imaging room 15, an CR apparatus 2c configured by an imaging apparatus 201 and a reading apparatus 202 is disposed. Further, next to the X-ray imaging room 15, an examination room 16 is provided, and an endoscope apparatus 2b is disposed therein.

As mentioned above, in this embodiment, a waiting room 12 having a reception 11, a diagnosis room 13, an X-ray imaging room 15, and an examination room 16 are positioned on the same floor, and a patient subject to medical examination, imaging, and examination can perform a series of operations such as reception, movement to the diagnosis room, medical examination by interview, movement to the imaging room and examination room, execution of photographing and examination instructed by a doctor, returning again to the diagnosis room, and medical check and diagnosis by the doctor on the basis of the generated photographed image only by moving comparatively short distances such as in the respective rooms and a passageway 14. Further, the arrangement of the rooms and apparatuses is not limited to the one shown in FIG. 2.

An diagnosis system 1 in an embodiment of the present invention will be described hereinafter.

Firstly, the configuration of respective apparatuses will be described.

An image generating apparatus 2 is a modality for photographing subject region of a patient to be examined as an object, converting the photographed image into a digital form and forming image data of the photographed image (photographed image data), the image generating apparatus 2 being configured by, for example, an ultrasound diagnosis apparatus 2a, an endoscope apparatus 2b and an CR apparatus 2c.

The ultrasound diagnosis apparatus 2a is configured by an ultrasound probe for outputting ultrasound and an electronic apparatus for converting the sound waves (echo signals) received by the ultrasound probe into the image data of the photographed image of internal organization (both are not shown). The ultrasound diagnosis apparatus 2a is arranged to transmit ultrasound from the ultrasound probe into the body, to receive the sound waves (echo signals) reflected by the body organization via the ultrasound probe again and to form a photographed image corresponding to the echo signals with the electronic apparatus.

A converting apparatus 20, which is a converting device (a converter) for converting analog signals to digital signals, is connected to the ultrasound diagnosis apparatus 2a. The ultrasound diagnosis apparatus 2a is connected to network 6 via the converting apparatus 20. By interfacing the converting apparatus 20, even when the data, which does not meet the standard (for example, communications protocols) of the external apparatuses connected to the network 6, is outputted from the ultrasound diagnosis apparatus 2a, it becomes possible to transmit and receive data between the ultrasound diagnosis apparatus 2a and the external apparatuses connected to the network 6 by appropriately conducting conversion.

In a conversion apparatus 20, there is provided an input operation section 20a including an input section configured by, for example, a ten-key, a keyboard and a touch panel, and a display section configured by a monitor such as a CRT (Cathode Ray Tube) or a LCD (Liquid Crystal Display) (both are not shown). The input operation section 20a is used to input a search ID (reception number in this embodiment) set in correspondence to a patient who is an imaged object and works as display device for displaying a patient list. A converter 20 supplements the search ID and the like inputted by the input operation section 20a to the image data of the photographed image.

Meanwhile, the search ID, when searching for a photographed image after photographing, is identification information for identifying a patient who is an imaged object and here it is regarded as a reception number to be given to the patient when he checks in. In this embodiment, the small-scale diagnostic system 1 is a system for generating and issuing beforehand no examination order information of a patient, preceding photographing of the patient, generating digital photographed image data, and then correlating the patient information to the photographed image by a doctor. It is the search ID that is used for this correlating.

In the case where reception number is inputted as search ID through the input operation section 20a, for example, when photographing the patient having a reception number “01”, which has been given by the reception desk 11, a technician inputs “01” as a search ID corresponding to the patient registration card the patient brought. In the small medical clinic, in normal situation, the number of patients visiting the clinic is about 10 (ten)-40 (forty). Thus, two-digit serial number will be enough for the serial number of a patient registration card. Consequently, the input operation section 20a may be configured so that two-digit number can be input and therefore, an inexpensive ten-key keypad is preferable. The configuration of the input operation section 20a is not limited to the one, which has been described above. For example, an input operation section having a card reader for reading information written on a card by inserting the card to the card reader or a bar code reader for reading bar code may be used.

Further, also in another image generating apparatus 2, similarly, the search ID is inputted. Further hereinafter, a case that the reception number is used as a search ID will be explained as an example, however as described later, the search ID is not limited to the reception number. It is desirable to be capable of confirming the patient name comparing with the displayed patient list which has been made at the reception computer 5.

Further, the information supplemented to the photographed image inputted from the input operation section 20a is not limited to the search ID. Various information for identifying a patient, such as the name of the patient may be inputted from the input operation section 20a. The identification number given to the image generating apparatus 2 executing the imaging or information for identifying the imaging kind such that the imaging is simple imaging using no contrast agent or imaging using a contrast agent may be inputted. The inputted search ID and other information are supplemented to the image data of the photographed image as supplementary information such as header information and when the image data is to be transmitted to an external device, these information is also transmitted while correlated with the image data.

Further, when the search ID is inputted from the input operation section, a constitution may be used so that the identification number (IP address) given beforehand to each of the image generating apparatuses 2 and information for specifying the type of imaging which is intrinsic to the type of apparatus are automatically supplemented.

The endoscope apparatus 2b is an apparatus in which a small sized imaging device is provided on the edge portion of the pipe having flexibility (not shown). The imaging device is configured by an objective optical system including an optical lens, an imaging section disposed at the focusing point of the objective optical system and a lighting section for conducting lighting necessary for photographing, which is configured by a LED (Light Emitting Diode) (not shown) or the like. An imaging section includes a solid state-imaging element, such as CCD (Charge Coupled Device) and CMOS (Complementary Metal-Oxides Semiconductor) to convert the amount of incident lights to electric signals corresponding to the amount of the incident lights when light flux enters into the imaging section. The objective optical system is arranged so as to converge the light flux on the area irradiated by the lighting section and forming an image onto the solid state imaging element provided in the imaging section. The imaging section is arranged to output image data of the photographed image as electric signals by converting the light flux entering into the solid state imaging element.

Further, although not drawn, also in an endoscope apparatus 2b, similarly to the input operation section 20a of the converter 20 of an ultrasound diagnosis apparatus 2a and the reading apparatus 202 of a CR apparatus 2c, at the time of imaging, an information supplementing device, which is built in or externally connected, for supplementing the search ID to the image data is installed and the search ID of the patient is supplemented to the image data of the generated photographed image.

With respect to the search ID inputted from the information supplementing device, as the same as the input operation section 235 described above, for example, the reception number is used. As described above, in the small medical clinic, normally, the number of patients per day is 10-40. Accordingly, two digits are enough for the serial number of the patient registration card. Consequently, with respect to the identification information input device, it is preferable to use a less expensive ten-key, which is capable of inputting this two-digits number.

Further, when the display section is provided together with this information supplementing device, this display section may function as the display device for displaying the patient list.

An imaging apparatus 201 composing the CR apparatus 2c has a radiation source (not drawn), applies radiation to a patient (not drawn) who is an examined object, thereby takes a radiographic image. At the time of imaging, in the irradiation area of the radiation irradiated from the radiation source, for example, a cassette including a built-in stimulable phosphor plate having a stimulable phosphor layer for storing radiation energy (they are all not drawn) is arranged, and the radiological dosage according to the radiation transmission factor distribution at the imaged part of an examined object (patient) to the applied radiological dosage from the radiation source is stored in the stimulable phosphor layer of the stimulable phosphor plate built in the cassette and radiographic image information of the examined object is recorded in the stimulable phosphor layer.

The CR apparatus 2c is an apparatus for reading the image stored in the stimulable phosphor, thereby generating image data of the photographed image. The CR apparatus 2c has a type in which the reading apparatus (radiographic image reading apparatus) having the radiation source and the stimulable phosphor is built in and one CR apparatus executes from capturing image to reading by itself and another type in which a portable cassette storing the stimulable phosphor plate is used. In this embodiment, the CR apparatus of the type using the cassette will be described as an example, however the CR apparatus is not limited to it.

The CR apparatus 2c is composed of the imaging apparatus 201 having a radiation source and the reading apparatus 202 for reading an image from the stimulable phosphor plate stored in the cassette used in the imaging apparatus 201 for radiography and for generating photographed image data (refer to FIG. 2).

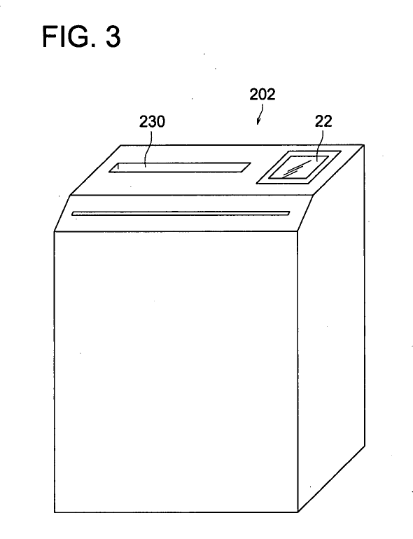

The reading apparatus 202, as shown in FIG. 3, has an insertion entrance 230 for inserting and loading the cassette having the built-in stimulable phosphor plate storing the radiographic image information of the examination object (patient) and it is an image generating device for taking out the stimulable phosphor plate from the cassette by a taking-out and conveying mechanism not drawn when the cassette is inserted into the insertion entrance 230, reading the radiographic image information of the examination object from the stimulable phosphor plate, and generating image data of the photographed image (photographed image data).

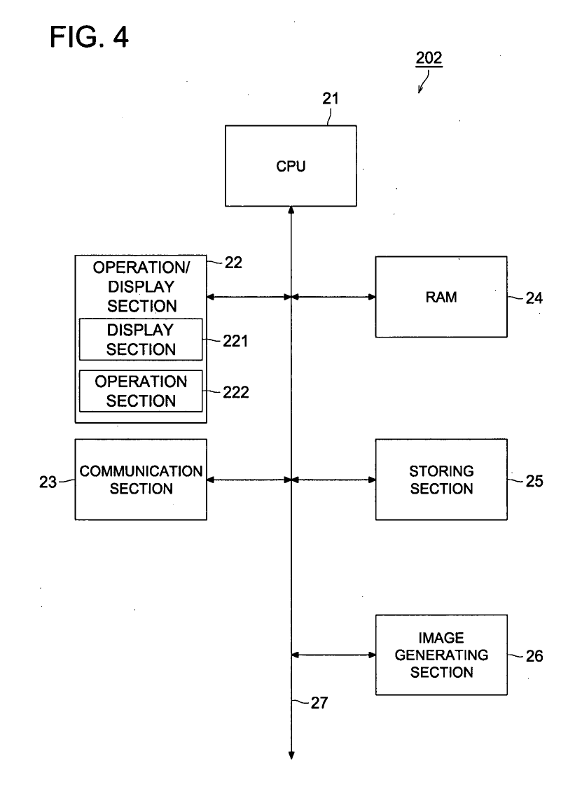

FIG. 4 is a block diagram showing the functional constitution of the reading apparatus 202. As shown in FIG. 4, the reading apparatus 202 includes a CPU (Central Processing Unit) 21, an operation/display section 22, a communication section 23, a RAM (Random Access Memory) 24, a storing section 25, and an image generating section 26 and the respective sections are connected by a bus 27.

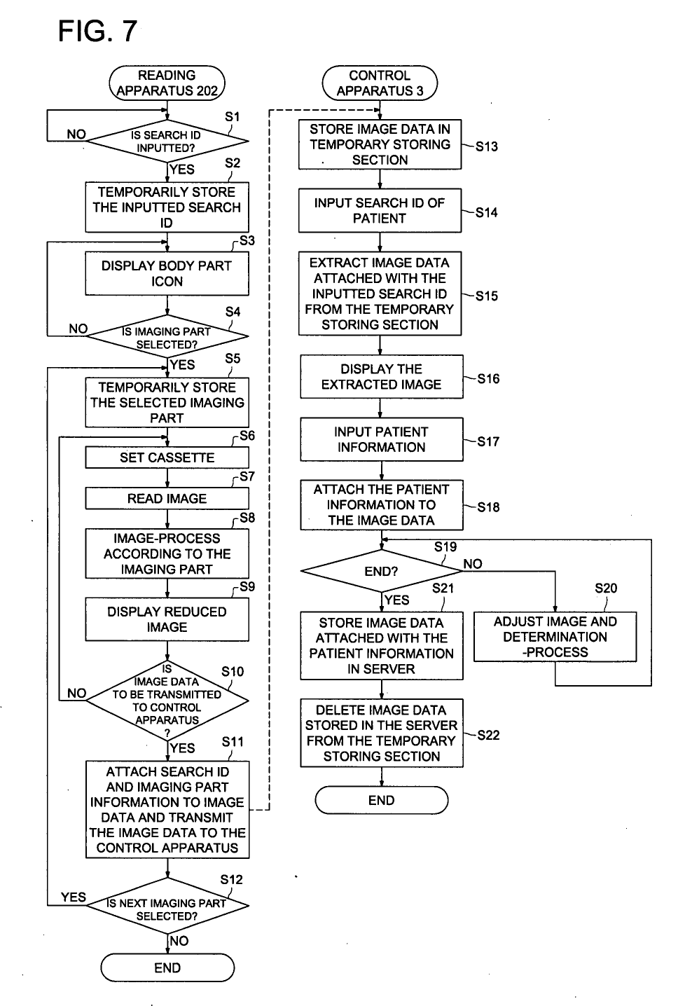

The CPU 21 reads the control program stored in the storing section 25, expands it in the work area formed in the RAM 24, and controls each section of the reading apparatus 202 according to the control program. Further, the CPU 21, according to the control program, reads various processing programs stored in the storing section 25 and expands them in the work area, and by cooperation with the read programs, executes various processes beginning with the process of the reading apparatus 202 side shown in FIG. 7.

Further, the communication section 23 is composed of a network interface, transmits and receives data with an external device connected to a network 6, and particularly functions as a transmitting device for transmitting photographed image data to the control apparatus 3 according to a transmission instruction from the operation/display section 22.

The RAM 24, in various processes executed and controlled by the CPU 21, forms a work area for temporarily storing various programs which can be executed by the CPU 21, input or output data, and parameters which are read from the storing section 25.

The storing section 25 is composed of an HDD (hard disc) and a semiconductor nonvolatile memory. In the storing section 25, various programs and various data for performing various processes such as the image generating processes and the data reducing process which are executed by the CPU 21 as mentioned above are stored.

The image generating section 26 is a reading device which is structured so as to be capable of setting the cassette used for radiography and takes out the stimulable phosphor plate from the set cassette and scans with exciting light, stimulates to get light emitted based on the radiographic image information stored and retained in the stimulable phosphor plate, and generates image data on the basis of an image signal obtained by reading photoelectrically the stimulated and emitted light.

The image generating section 26 is an image generating device composed of an exciting light source (not drawn) for irradiating exciting light such as a gas laser beam, a solid laser beam, or a semiconductor laser beam to the stimulable phosphor plate recording the radiographic image information and a photomultiplier (not drawn) for detecting light due to the stimulated light emission generated by irradiation of the exciting light from the exciting light source. The image generating section 26, on the basis of a control signal such as a reading sampling pitch instruction signal from the control apparatus 3, converts photoelectrically, by the photomultiplier, the stimulated and emitted light generated from the stimulable phosphor plate by the exciting light irradiated from the exciting light source and generates an image signal. Furthermore, the image generating section 26 converts the obtained image signal from analog to digital, thereby forms a photographed image based on the radiographic image information recorded on the stimulable phosphor plate.

Further, in this embodiment, the CR apparatus 2c of a cassette type using a portable cassette storing the stimulable phosphor plate is described as an example, however the CR apparatus 2c is not limited to it. The CR apparatus 2c may be an integral apparatus in which the imaging apparatus 201 and reading apparatus 202 are united and from photographing to reading are executed by itself.

When a photographed image is formed by the image generating section 26, the CPU 21, as mentioned above, by the software process in cooperation with the data reducing process program stored in the storing section 25, functions as a reduction processing device for performing the data reducing process for generating reduced image data (image data of a smaller information amount than that of the image data of the photographed image) that the data is reduced on the basis of the image data of the photographed image.

Specifically, for example, when the sampling pitch of the image data of the photographed image is 100 μm, by performing the data reducing process of reducing the length and width respectively to 1/16, reduced image data of a sampling pitch of about 1.6 mm is generated. The reducing process algorithm for performing the data reducing process is not restricted particularly and any method may be used such as taking the average of neighboring pixel values or thinning out pixels at a fixed pixel interval. Further, in what degree the photographed image is reduced to generate reduced image data is not restricted particularly, however the reduced image data must be an image on a level necessary to judge suitability of photographing when displayed on the display section 221 of the operation/display section 22 which will be described later or to judge especially suitability of the positioning of a patient who is an imaged object, and such a level is sufficient. For example, the reduced image data may be on a level necessary to confirm the outline of the object imaged when displayed on the display section 221.

The operation/display section 22 is composed of the display section 221 and operation section 222. The display section 221 is composed of a display screen having an LCD (Liquid Crystal Display) and according to the instruction of a display signal inputted from the CPU 21, displays a patient list on the display screen.

The operation/display section 22 includes, for example, the display section 221 which is a display device composed of a display screen such as a CRT (Cathode Ray Tube) or an LCD (Liquid Crystal Display) and the touch panel 222 formed so as to cover the display screen and the touch screen is integrally composed of the display section 221 and touch panel 222.

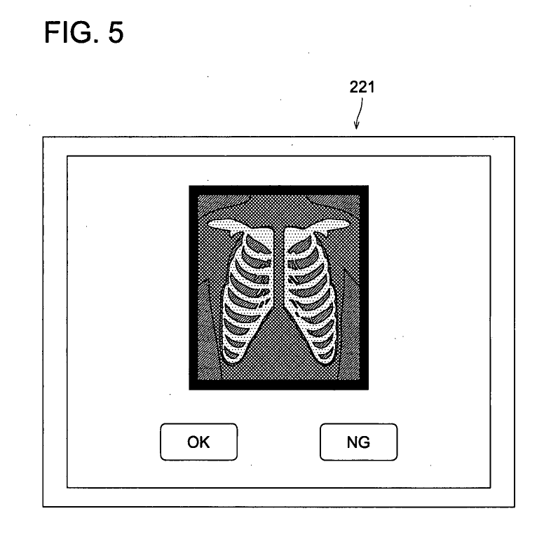

The display section 221, according to the instruction of the display signal inputted from the CPU 21, displays a reduced image based on the reduced image data, various selected screens, and an instruction screen on the display screen. For example, as mentioned above, when the reduced image data is generated by the CPU 21, as shown in FIG. 5, the reduced image based on the reduced image data is displayed on the display section 221. Further, on the display section 221, for example, the operation buttons such as the OK button and NG button are displayed. As a result of confirmation of the reduced image by an operator, when the positioning is appropriate, the OK button is operated, thus a transmission instruction for transmitting the photographed image data corresponding to the reduced image to the control apparatus 3 can be inputted and when the imaging is inappropriate, the NG button is operated, thus a re-photographing instruction can be inputted. Further, the contents displayed on the display section 221 are not limited to the illustration in the drawing and for example, a patient list may be displayed on the display section 221.

The touch panel 222 is, for example, a pressure-sensitive (resistive film pressure type) panel in which transparent electrodes are arranged in a lattice shape and is structured so as to detect the XY coordinates of the force point pressed by a finger or a touch pen by a voltage and output the detected position signal to the CPU 21 as an operation signal.

For example, when an input instruction screen for inputting the search ID of a patient who is an imaged object is displayed on the display section 221 and when the input operation is performed from the touch panel 222 formed on the display section 221, various input operations can be performed. Namely, for example, as the display of the OK button, on the display section 221, a screen for inputting an instruction for transmission of the photographed image data generated by the image generating section 26 to the control apparatus 3 can be displayed and a user, by pushing the OK button on the touch panel 222 formed on the display screen of the display section 221, can input the transmission instruction of the photographed image data. In this case, the operation/display section 22 functions as a transmission instruction input device for inputting the transmission instruction of the photographed image data. Further, on the display screen of the display section 221, the ten-key buttons are displayed and when reading the radiographic image information from the cassette and generating photographed image data, the operation/display section 22 functions as an information supplementing device for supplementing the search ID of the patient to the photographed image data.

The operation section 222 is composed of the ten-key pad and outputs a pressed signal of a pressed key of the ten-key pad to the CPU 21 as an input signal. Further, the operation section 222 has a touch panel installed so as to cover the top surface of the display section 222, and detects the pressed position inputted by an operation using a finger of a user and outputs the detection signal to the CPU 21.

As the details will be described later, in display section 221, a human body icon which accepts selection of a part to be radiographed that is an imaging part, is displayed and the operation section 222 has a function to input the selection of the part by pushing any part of the human body icon. Normally, the display section of the reading apparatus is relatively small, however the above mentioned icon can be recognized even though letters are difficult to be judged and therefore it prevents mis-selections and is preferable. The chosen part is selected as the imaging part and the image processing is conducted according to the selection.

The control apparatus 3 is placed at, for example, a diagnosis room 13 and is a workstation, on which image data of captured image sent from the image generating apparatus 2 are correlated with patient information or a medical doctor displays images and conducts diagnosis by analyzing the images. The workstation may have a monitor (a display section) having higher definition than the definition of display section of a normal PC (Personal Computer).

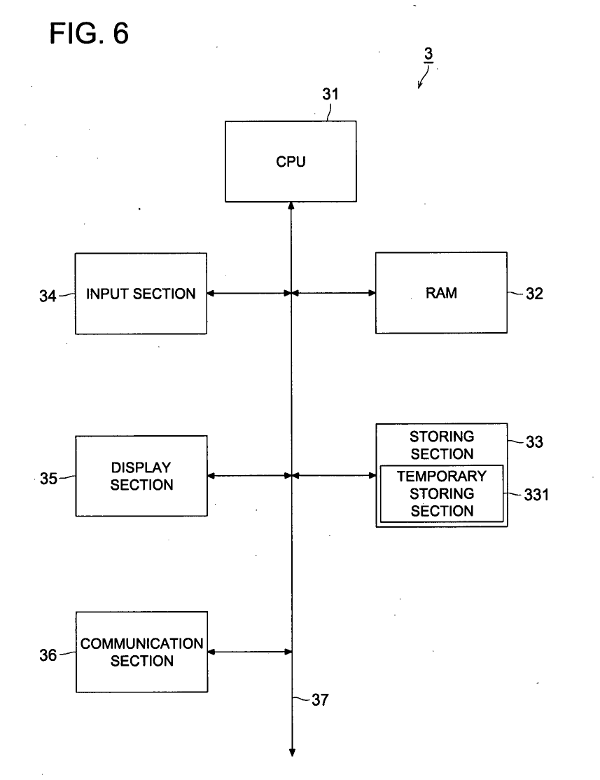

FIG. 6 is a block diagram showing a functional structure of control apparatus 3. As shown in FIG. 6, the control apparatus 3 is configured by a CPU 31, a RAM 32, a memory section 33, an input section 34, a display section 35 and a communication section 36, and respective sections are connected to bus 37.

The CPU 31 is arranged to read out various programs including a system program and process programs stored in the memory section 33 and expand them in the RAM 32. The CPU 31 is arranged to execute various processes including the processes on the control apparatus 3 shown in FIG. 7 according to the expanded programs.

A RAM 32, in various processes executed and controlled by a CPU 31, forms a work area for temporarily storing various programs which can be executed by the CPU 31, input or output data, and parameters which are read from the storing section 33.

The memory section 33 is configured by a HDD (Hard Disk) and a semiconductor non-volatile memory. The memory section 33 is storing system programs and other various programs to be executed in CPU 31, region identifying parameters (a lookup table for correlating the outline of the object appeared in the image and the shape with the photographed region) for identifying the photographed region as described in the specifications of Japanese patent application publication No. H11-85950 Open to Public inspections and Japanese patent application publication No. 2001-76141 Open to Public inspections and image process parameters (a lookup table defining the gradation curve used for a gradation process and the emphasis degree of a frequency process) for conducting image processing corresponding to the identified photographed region.

Further, the memory section 33 is arranged to temporally store image data of the photographed image formed by the various image generating apparatuses 2. When the Search ID, patient information, information related to the type of photographing and information for identifying the image generating apparatus 2 used for the photographing are added to the photographed image data, the photographed image data are correlated with these information items and stored into the memory section 33. Other than this, the memory section 33 stores various information items, which have been transmitted to the control apparatus 3, such as a patient list, which has been formed in order of reception of the patients.

An input section 34 comprises a keyboard having a cursor, numeral input keys and various function keys, and a pointing device, such as, a mouse (any of them not shown). The input section 34 is arranged to be capable of inputting a patient name, which is patient information for identifying the subject patient. The input section 34 is also arranged to transmit instruction signals inputted by the key operation to the keyboard and mouse operation to the CPU 31.

Here, with respect to the patient information inputted from the input section 34, they can be, for example, a patient name and a patient registration card number. However, the patient information is not limited to these described here. A search ID is to become an identification sign for identifying the examination object when retrieving the photographed image after the photographing and, for example, the reception number given by the reception when check in may be the identification sign. In this embodiment, an example in which a patient name is inputted as patient information and a reception number is inputted as a search ID will be described.

A display section 35 is configured by a monitor including, for example, a CRT (Cathode Ray Tube) or a LCD (Liquid Crystal Display). As described later, the display section 35 is a display device for displaying photographed images based on the photographed image data and various patient information items. The display section 35 displays various screens according to the instructions of the display signals inputted from the CPU 31.

A communication section 36 is configured by network interface. The communication section 36 is arranged to conduct data communication via a switching hub with external apparatuses connected to the network 6. Namely, the communication section 36 is a receiving device for receiving image data of the photographed image formed by the image generating apparatus 2 and is also an output device for outputting image data of the photographed images, the image process of which has been completed and confirmed, to the external apparatus, such as a sever 4 when necessary.

Next, the various processes performed by the CPU 31 will be described.

In this embodiment, the CPU 31 functions as an image extraction device for extracting only image data of photographed image taken for a specific patient among the photographed image data stored in the memory section 33 based on the search ID or the division information for dividing patients. Namely, as described above, in the case where the search ID, which has been correlated with the patient information of the subject patient, has been inputted from the input operation section 20a or the operation/display section 22 of the reading apparatus 202 when photographing, this search ID is added to the image data of the photographed image as header information. When an operator, such as, a medical doctor inputs instruction signals for extracting the photographed image corresponding to the search ID from an input section 34, the CPU 31 retrieves the photographed image having the search ID, extracts and displays the photographed image onto the photographed image display screen 351 of the display section 35.

Further, the CPU 31 performs the image processing of the image data of the photographed images, which have been formed by the image generating apparatus 2 and received by the communication section 36, corresponding to the photographed region of the body and functions as an image processing device for forming photographed image suitable for the diagnosis.

The CPU 31 reads out the image process parameters corresponding to the photographed region from the memory section 33, determines the image process conditions based on the read parameters and applies the image processing to the image data, such as a gradation process for adjusting contrast of the image, a process for adjusting density and a frequency process for adjusting sharpness based on the determined image process conditions. Further, when an operator, such as a medical doctor inputs the adjustment of the density or the contrast of the photographed images from an image process condition adjustment field 351e, the CPU 31 performs the image processing of the photographed images corresponding to this operation. Then, when completing the image processes and having pushing down the OK button 353, the CPU 31 determines the image data of the photographed images, to which image processing has been applied, as the diagnosis image data of the photographed image.

Further, when the patient information for identifying the photographed examination object has been inputted, the CPU 31 replaces the patient information, such as this patient name, with the search ID, conducts the process for correlating the patient information to the photographed image data, to which a certain image process has been applied, and functions as a device for correlating the photographed image data to the patient information and storing them. The CPU 31 writes and stores the photographed image data correlated to the patient information into the memory section 33 or an image database DB 40 of the server 4.

Further, the CPU 31 may be arranged to transmit the instruction signal to a reception computer 5 so as to send information of a predetermined patient among the reception related information stored in reception DB 50, as described later. When the reception computer 5 has transmitted the reception related information, the CPU 31 correlates the reception related information to the photographed image data, to which the same patient information as the reception related information has been correlated. When the patient information, the reception related information and the photographed image data are correlated each other, the CPU 31 writes and stores the patient information, reception related information and the photographed image data, which have been correlated each other into the image database DB 40.

In FIG. 1, a server 4 is a computer configured by a memory section including a CPU, a RAM and a HDD, and a communication section (any of them is not shown) for controlling communications with various apparatuses connected to network 6. The server 4 including image database DB 40, correlates the image data of photographed images, to which the control apparatus 3 gives the writing instruction via communication section, with the supplemented information (information including patient information) and stores them to the image database DB40 as an image storing device by executing software process under the collaboration of programs stored in CPU and memory section. Further the server 4 retrieves the image data and its supplemented information in the image database DB40 in response to the request from the control apparatus 3, reads the image data and its supplemented information corresponding to the request and transmits them to the control apparatus 3.

A reception computer 5 is composed of a storing section including a CPU, a RAM, and an HDD, an input section including a keyboard and a mouse, a display section including a CRT or an LCD, and a communication section (these sections are not drawn) for controlling communication with the devices connected to a network 6 and it is a computer for executing reception and registration, accounting and insurance point calculation for a patient visiting the clinic. The reception computer 5 has a reception DB50 for storing reception related information concerning a received patient which is inputted by an operator in charge of reception from the paper record card information of a doctor.

The structural part of the reception computer 5 will be described as follows.

The CPU reads out various programs such as a system program or process programs stored in the memory section, expands them in the RAM, executes various processes according to the expanded programs and functions as, for example, a reception registration device, a list generating device and a reception information generating device.

The memory section comprises a HDD (a Hard Disk) and a semiconductor non-volatile memory and stores the system program and various process programs executed by the CPU and various data.

The input section is configured by a keyboard including a cursor key, numeral input keys and various function keys, and a pointing device such as a mouse. The input section outputs the push-down signals of key by the push-down operation of the keyboard and operation signals of the mouse to the CPU as an input signals.

The display section includes a monitor, for example, a CRT or a LCD and displays various screens according to the instruction of the display signals inputted from the CPU.

A communication section is configured by network interface. The communication section conducts data communication between the external apparatuses connected to the network.

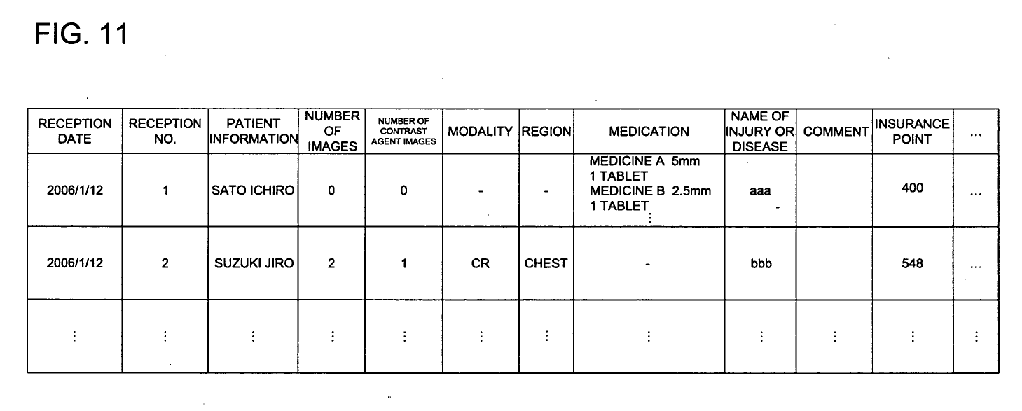

A reception DB 50 is a database for storing the reception related information related to the patient who visited to the clinic, which has been correlated with the patient information. An example of data storage of the reception DB 50 is illustrated in FIG. 11. The reception DB 50 is a database, in which the reception related information of respective patients who visited the clinic is stored. As shown in FIG. 11, the reception DB 50 includes a “reception date” row for storing the reception date of a patient, a “reception No.” row for storing the reception No., which has been given to the patient, a “patient information” row for storing the patient information (here, it is a patient name), a “number of images” row for storing the number of images of the patient photographed on the reception date, a “number of contrast agent images” row for storing the number of images in which the contrast agent has been used, a “modality” row for storing the type of the image generating apparatus 2 used for the photographing, a “region” row for storing the photographed region, a “medication” row for storing the information of medicine prescribed for the patient on the reception date, a “name of injury or disease” row for storing the name of injury or decease, which the medical doctor diagnosed on the reception date, a “comment” row for storing the comment inputted from a control apparatus 3, which will be described later and an “insurance point” row for storing calculated insurance points.

Next, in a small-scale facility to which the small-scale diagnostic system 1 is applied, the flow of processing for a patient from visiting to leaving the clinic will be explained.

When the patient visits the clinic, firstly, at the reception 11 shown in FIG. 2, from a person in charge of reception, a number ticket is given to the patient visiting the clinic, and the patient name is confirmed. Next, in the reception computer 5, the person in charge of reception operates the input section to display a reception input screen (not drawn) and inputs patient information such as the reception No. and patient name from the input section. In the reception computer 5, when the reception No. and patient information are inputted from the reception input screen, a new record is added to the reception DB50 and the reception date, reception No., and patient information are written and registered.

The patient given the reception No. stands by in the waiting room 12 and then moves to the diagnosis room 13. In the diagnosis room 13, the patient is subject to a medical examination by interview of a doctor and the imaging to be executed for the patient (the type of an image generating apparatus 2, imaging part, imaging direction, number of images, etc.) and laboratory testing to be executed for the patient (blood test, urine and feces test, tissue slice sampling test, etc.) are decided.

When imaging of the affected part is decided to be necessary as a result of the medical examination by interview, the imaging operators for executing imaging such as a doctor and an imaging engineer take the patient over to the front of the image generating apparatus 2 (the ultrasound diagnosis apparatus 2a, endoscope apparatus 2b, or CR apparatus 2c) for imaging the patient, and in the image generating apparatus 2, via the input operation section (in the case of the CR apparatus 2c, the ten-key pad of the operation section 222), input the search ID described on the reception number ticket given to the patient, photograph the part of the patient to be examined as an object, and generate image data of the photographed image. For example, when an ultrasound diagnosis apparatus 2a is used as the image generating apparatus 2, the conductor of the photography inputs the reception number of the patient as the search ID from the input operation section 21a, or the operation/display section 235 of the reading apparatus 23 when the CR apparatus 2c is used as the image generating apparatus 2, so that the image generating operation of the image generating apparatus 2 becomes ready to start operation. When the examination reservation has been made in advance on the date, the patient may directly move from the reception desk to the imaging room 15 or the examination room 16 without receiving the medical examination by interview.

FIG. 7 is a flow chart showing the detailed flow of the generating process of photographed image data of a patient executed by the reading apparatus 202 and control apparatus 3 and the correlating process of the photographed image data to the patient when imaging by the CR apparatus 2c is decided to be necessary as a result of the medical examination by interview of the doctor. Hereinafter, by referring to FIG. 7, the flow of the generating process of photographed image data of a patient by the reading apparatus 202 and the correlating process of the photographed image data to the patient by the control apparatus 3 will be described together with the work flow of the intra-facility staff (doctor, imaging engineer, person in charge of reception).

Firstly, the imaging operator inputs the search ID from the ten-key pad of the operation section 222 installed on the reading apparatus 202.

In the reading apparatus 202, when a key of the ten-key pad of the operation section 222 is pressed and the search ID is inputted (Step S1), the inputted search ID is temporarily stored in the RAM 24 (Step S2) and on the display section 221, the human body part icon for receiving selection of the part of the imaged object, that is, the imaging part is displayed (Step S3).

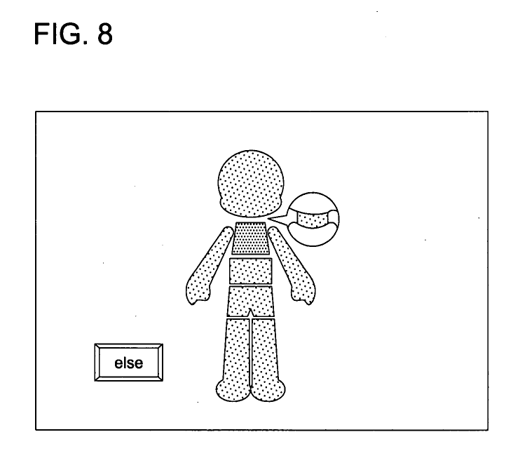

FIG. 8 shows a display example of the human body part icon on the display section 221. The body part icon is a body-shaped icon including the selectable parts (for example, the head, neck, chest, abdomen, pelvis, limbs, and other parts) into which the human body is roughly divided and when any part is chosen and inputted from the body part icon by being pressed, the pressed position is outputted to the CPU 21 from the touch panel of the operation section 222, and the chosen part is selected as an imaging part. Further, a constitution may be used so that the body part icon is only displayed, and according to the pressing count of a prescribed key (in FIG. 8, the key “else”), the respective parts of the body part icon blink sequentially (for example, by pressing one time, the head blinks, by pressing two times, the neck blinks, - - - ), and the part in the blinking state when the cassette is set is selected as an imaging part. By doing this, regardless of the size of the display section 221 and even if the touch panel cannot recognize correctly pressing of each part of the body part icon, the imaging part can be selected correctly.

The imaging operator, when the body part icon is displayed on the display section 221, selects the part to be imaged from the body part icon. And, in the imaging apparatus 201, the operator sets the cassette, executes radiographing of the imaging part selected from the body part icon for the patient, and sets the cassette after photographing on the reading apparatus 202.

In the reading apparatus 202, when the imaging part is selected from the body part icon (Step S4), the information of the selected imaging part is stored temporarily in the RAM 24 (Step S5). Next, the reading apparatus 202 waits for setting of the cassette, and when the cassette is set (Step S6) in the image generating section 26, the radiographic image information recorded on the stimulable phosphor plate built in the cassette is read, and image data is generated on the basis of the imaging part selected at Step S4 (Step S7). Specifically, the stimulable phosphor plate is taken out from the cassette set in the image generating section 26 and is scanned with exciting light, and the radiographic image information recorded on the stimulable phosphor plate is stimulated and emits light, and the emitted light is read photoelectrically, thus an image signal is obtained, and the image signal is converted from analog to digital at a predetermined sampling pitch according to the imaging part, thereby image data is generated.

When the image data is generated, the image process according to the selected imaging part is performed on the basis of the imaging part selected at Step S4 (Step S8). For example, in the storing section 25, a program of extracting the ROI (Region Of Interest: region noticed from the viewpoint of diagnosis) according to the imaging part is stored for each imaging part, and the extraction program according to the image part selected at Step S4 is read, and the ROI is extracted. After extraction of the ROI, a histogram of image signal values in the ROI is prepared, and the normalization process for correcting changes in the X-ray dose caused by variations in the physique of a patient and photographing conditions is performed on the basis of the prepared histogram, and after the normalization process, the gradation process for adjusting the density and contrast of the photographed image is performed. In the storing section 25, the gradation conversion curves according to the respective imaging parts are stored and using the gradation conversion curve according to the imaging part selected at Step S4, the gradation process is performed for the image data.

When the photographed image data is generated by the reading apparatus 202, the CPU 21 of the reading apparatus 202 generates reduced image data having an information amount smaller than that of the photographed image data, as a reduction processing device for performing the data reducing process, on the basis of the photographed image data. And, the CPU 21 displays the reduced image based on the reduced image data on the display screen of the display section 221 (Step S9). The imaging operator (imaging engineer or doctor) confirms the display on the display section 221, thereby can judge suitability of imaging, particularly suitability of the positioning of the patient and when the photographing is executed at appropriate positioning, the imaging operator inputs a transmission instruction for transmitting the photographed image data to the control apparatus 3 (YES at Step S10.

When the transmission instruction is inputted, in the reading apparatus 202, the search ID inputted at Step S1 and the information at the imaging part selected at Step S4 are written into the header portion of the processed image data as supplementary information and are transmitted to the control apparatus 3 via the communication section 23 (Step S11). When photographing a patient, who has not stopped by the reception desk in an emergency situation or the like, it becomes possible to extract the image data after photographing with clear distinction of other image data as the same as the normal flow by setting a predetermined code showing an emergency interruption, for example, “99”, which does not appear in a normal photographing, as a division information. When selection of the next imaging part from the body part icon displayed on the display section 221 is detected (YES at Step S12), the process is returned to Step S5 and the processes at Steps S6 to S9 are executed repeatedly for the next imaging part.

In the control apparatus 3, when the image data (the supplementary information is included) is received from the image generating apparatus 2, the received image data is stored in a temporary storing section 331 (Step S13).

When the imaging is finished, the patient moves to the diagnosis room 13. The doctor operates an input section 34 of the control apparatus 3 to display an image search screen not drawn on the display section 35 and inputs the search ID shown on the reception number ticket of the objective patient. In the control apparatus 3, when a display instruction of the image search screen is inputted from the input section 34, the image search screen for receiving input of the search ID is displayed on the display section 35, and when the search ID is inputted from the screen via the input section 34 (Step S14), the image data including the inputted search ID recorded in the supplementary information is extracted from the temporary storing section 331 (Step S15), and a thumb-nail image which is a reduced image of the extracted image data is prepared and is displayed on the photographed image display screen 351 of the display section 35 (Step S16).

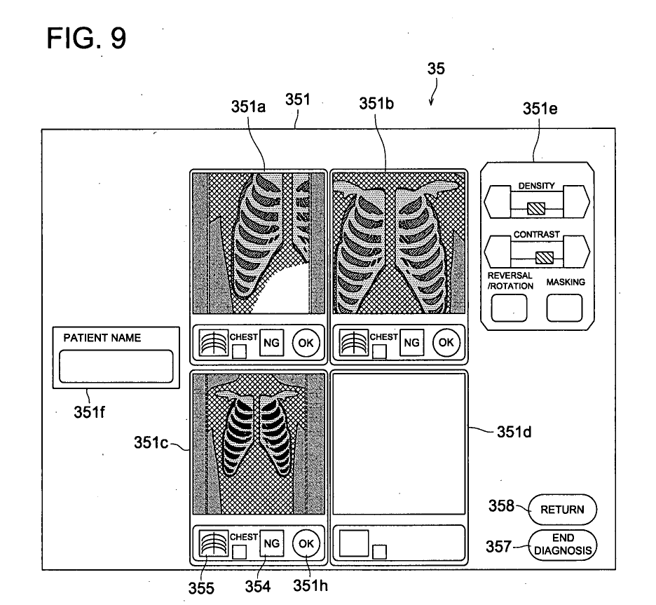

FIG. 9 shows a display screen example of the photographed image display screen 351 displayed on the display section 35. As shown in FIG. 9, the photographed image display screen 351 has image display fields 351a to 351d for listing the extracted images. When any of the image display fields 351a to 351d is selected by the mouse of the input section 34, the life-size image of the selected image is independently displayed. The doctor, from the independent displayed image, can observe the image in detail and make a photo check diagnosis. Further, on the upper right of the screen, an image process adjustment field 351e is provided and the doctor operates the image process adjustment field 351e by the mouse, thereby can adjust the density and contrast. Further, arranged in the image display fields 351a to 351d are an OK button 351h corresponding to each display field of the image display fields 351a to 351d for confirming the photographed image displayed in each display field and storing the image data of the photographed image, which has been confirmed, a NG button for instructing the deletion of the image data of photographed image displayed on each display field and re-outputting of the image data and a photographed part display field 355 for displaying the photographed region, which shows the region of the patient has been photographed for respective photographed images. When the OK button 351h shown corresponding to each image is pressed, the displayed image can be determined as an image to be preserved in an image DB40. Further, on the photographed image display screen 351, a patient information input field 351f for receiving input of patient information of a patient corresponding to the displayed photographed image is provided. The doctor inputs the patient information from the patient information input field 351f. When storing the confirmed image data of the photographed image, a mark showing that the related image has been stored may be displayed in each display field of the image display fields 351a to 351d.

Further, on the photographed image display screen 351, a patient name field 351f for inputting and displaying the patient name as patient information is provided. In this embodiment, the example, in which the patient name field 351f is provided as an input and display field of the patient information, will be described hereinafter. However, the input and display field of the patient information is not limited to the one described here as an example.

Other than this, in the photographed image display screen 351, a diagnosis end button 357 for completing the diagnosis and a return button 358 for returning to the previous display screen are provided. Here, the configuration of the photographed image display screen 351 is not limited to the example shown in FIG. 9. For example, a display field for displaying other than these described above or a button other than these described above may be provided. For example, the display field for displaying a reception number corresponding to the patient list may be provided.

When the patient information of the patient to be examined is inputted from the patient information input field 351f via the input section 34 (Step S17), the search ID of the supplementary information of the image data extracted at Step S15 is written on the inputted patient information and the patient information is made correspond to the image data (Step S18). Until ending of the diagnosis is instructed by pressing the end button of the photographed image display screen 351 (NO at Step S19), according to an instruction of image process adjustment and image decision from the photographed image display screen 351, the image adjustment process and image decision process are performed (Step S20). When ending of the diagnosis is instructed by pressing the end button of the photographed image display screen 351 (YES at Step S19), the image data with the patient information supplemented is transmitted to a server 4 via a communication section 36 and is stored in the image DB40 (Step S21). And, the image data written into the image DB40 of the server 4 is deleted from the temporary storing section 331 (Step S22) and the process is finished. When the image process corresponding to the photographed region has not been appropriately conducted, the parameter correction may be conducted by reflecting the density and contrast adjustment of the photographed image conducted via the image process condition adjustment field 351e to the image process parameters. When the photographed images displayed on respective display fields are indistinct and the density and contrast adjustments cannot correct the indistinctness, the medical doctor operates the NG button 354 to instruct the deletion of the image data of the photographed image and the re-output of the image data of the photographed image from the image generating apparatus 2.

Further, if imaging by the image generating apparatus 2 other than the CR apparatus 2c is decided by the medical examination by interview, when the search ID is inputted from the input operation section of the image generating apparatus 2 decided to be used and the patient is photographed, the inputted search ID is written into the header portion of the image data of the photographed image and is transmitted to the control apparatus 3. The flow of the processes in the control apparatus 3 is the same as that of the processes at Steps S13 to S22 shown in FIG. 7.

When the diagnosis of the patient in the diagnosis room is finished, the patient moves to the reception 11 and settles the account. The medical doctor conducts examination while watching the photographed image after the determination of the photographed image. The medical doctor writes down his or her diagnosis of the patient (name of injury or disease), the medication information indicating the prescribed medicine for the patient, the information related to the photographing and examination conducted to the patient (the type of apparatus used for the photographing, the number of images, yes or no of the usage of contrast agent images, the photographed region, the direction of photographing, the kind of examination, the examination ID) on the medical record sheet. The medical doctor writes the diagnosis on the medical record sheet, at the same time, correlates the image data of the photographed image, which has been photographed on the day, to the patient information, which has been inputted, (deeming the patient information as supplementary information of the patient) and stores them to the memory device, such as image DB 40 of the server 4.

The medical doctor gives the medical record sheet to the receptionist of the reception desk 11 after writing the diagnosis on the medical record sheet. The receptionist gets the examination information input screen displayed on the display section of the reception computer 5, and inputs the reception related information for the insurance point request process based on the medical record sheet from the input section via the examination information input screen. The CPU of the reception computer 5 works out the accounting related information relating to the insurance point calculations based on the number of images of the photographs for the patient, the kind of photograph such as simple radiographing by X-ray or contrast agent image radiographing, the type of the image generating apparatus 2 used for the photographing and information added to the image data of the photographed images. The reception related information, which has been inputted, and the insurance points, which have been calculated are correlated with the patient name, which is patient information, and written and stored into the reception DB 50. In the reception computer 5, on the basis of the inputted reception related information, the accounting information and insurance point calculation process for the patient is performed. The person in charge of reception, on the basis of the calculated accounting information, charges the patient for a fee for medical service and settles the account.

As explained above, according to the reading apparatus 202, when keys of the ten-key pad of the operation section 222 are pressed and the search ID is inputted, the body part icon is displayed on the display section 221. When one part is selected from the displayed body part icon and the cassette is set, the radiographic image information recorded on the stimulable phosphor plate built in the cassette is read by the image generating section 26, and image data is generated at a sampling pitch predetermined according to the imaging part, and the image processes such as the ROI extraction process and gradation process are performed for the generated image data according to the imaging part. The processed image data, after the information of the imaging part is written into the header portion, is transmitted to the control apparatus 3 by the communication section 23.

Therefore, in a small-scale facility, even if the input work of the examination order information is not executed, by a simple operation of selecting the imaging part from the body part icon displayed on the display section when reading an image by the reading apparatus 202, the process according to the imaging part can be performed without performing the part recognizing process for recognizing the imaging part from the beginning for the read image data, and the processing efficiency and diagnostic efficiency in the small-scale facility can be improved.

Further, the description contents of the embodiment aforementioned are a preferred example of the small-scale diagnostic system 1 relating to the present invention and the present invention is not limited to it.

For example, in the embodiment aforementioned, the image process is performed for the read image data by the reading apparatus 202, however it may be performed by the control apparatus 3. Also in this case, the imaging part is written as supplementary information of the image data, so that without performing the part recognizing process for recognizing the imaging part from the beginning by the control apparatus 3, it is enabled to read quickly the processing program and parameter according to the imaging part and perform the image process, thus the processing efficiency can be improved.

Further, it can be configured so that when the search ID is inputted to the reading apparatus 202, the search ID is transmitted to the control apparatus 3, and when the imaging part is selected, the imaging part information is transmitted to the control apparatus 3, and when image data is received by the control apparatus 3 from the image generating apparatus 2, the search ID and imaging part information which are transmitted immediately before from the reading apparatus 202 is correlated with the received image data, that is, to write them as supplementary information of the image data. By use of such a constitution, even when a patient is to be photographed by the image generating apparatus 2 other than the CR apparatus 2c, the imaging operator selects the search ID and imaging part of the patient at the reading apparatus 202 and then executes photographing, thereby the imaging part of the image data can be recognized at the control apparatus 3, so that when performing the image process by the control apparatus 3, there is no need to perform the part recognizing process from the beginning and it is enabled to read quickly the processing program and parameter according to the imaging part and perform the image process, thus the processing efficiency can be more improved.

Further, according to the diagnostic system 1 relating to this embodiment, the reduced image is displayed on the display section 221 of the reading apparatus 202 installed in the X-ray imaging room 15, so that the imaging operator can judge suitability of the positioning and motion artifact of the patient who is an imaging object at the reading apparatus 202 without moving out of the X-ray imaging room 15. Therefore, the imaging person can judge necessity of re-imaging earlier and improve the imaging efficiency. This embodiment is particularly effective in the work flow of a general clinic where a doctor is residing in the diagnosis room 13 and an assistant is residing in the X-ray imaging room 15.

Further, photographed image data and patient information concerning a patient corresponding to the photographed image data are correlated with each other by the correlating device of the control apparatus 3, so that even if the imaging order information is not inputted beforehand, the photographed image and patient can be simply correlated with each other.

Furthermore, the operation/display section 22 which is a touch screen composed of the display section 221 and touch panel 222 structured integrally serves as both a display device and a transmission instruction input device, so that there is no need to install separately operation buttons, and the apparatus constitution can be simplified, and a user can operate while obserbing the contents displayed on the display device, thus the operability can be improved.

Further, in this embodiment, used is the constitution of inputting the patient information from the input section of the reception computer 5, supplementing the search ID corresponding to the patient information to the image data of the photographed image at the time of imaging, thereby correlating the patient with the photographed image, however the constitution of correlating the patient with the photographed image is not limited to it.

For example, it is possible only to set the search ID assigned to each patient such as the reception number by selecting a patient from the patient list before photographing, and after photographing the patient information such as the patient name can be inputted when diagnosing the patient by observing the photographed image corresponding to the patient at the display section 35 of the control apparatus 3.

Furthermore, in such a use environment where there are only one doctor and one assistant in a facility and patients are photographed and diagnosed one by one, it can be configured so that when one patient is selected on a patient list confirmation screen 35a, the display section 35 is automatically switched to the photographed image display screen 351 and when the patient is photographed, the photographed image formed by the image generating apparatus 2 is displayed on the selected photographed image display screen 351. In this case, a plurality of patients are not simultaneously photographed in parallel, and the patients selected from the patient list have a one-to-one correlation with the photographed patients, and there is no risk of mistaking the patient for the photographed image. Therefore, there is no need to input the patient information before photographing and no need to input the search ID of the patient after photographing, thus the input operation can be minimized and the burden imposed on the doctor can be lightened. Further, when using such a system, a system constitution having no input operation section in the image generating apparatus 2 can be used.

Further, in the embodiment of the invention, there has been described an example, which includes an ultrasound diagnosis apparatus 2a, an endoscope apparatus 2b and an CR apparatus 2c as an image generating apparatuses 2. However, the image generating apparatus 2 needs to have only functions for photographing the subject patient and forming photographed images based on the imaged data obtained by the photographing, and is not limited to the example described above. It is possible to apply an arbitrary apparatus for forming photographed images, such as, an image generating apparatus using other radiographic image conversion medium, an image generating apparatus for obtaining image data without using radiographic image conversion media, and forming photographed images based on the image data and an image generating apparatus for taking out radiographic images as digital signals by using a radiation detector. Concretely, for example, a CT (Computed Tomography), a MRI (Magnetic Resonance Imaging), a FPD (Flat Panel Detector) and a mammography may be used other than the ultrasound diagnosis apparatus 2a, the endoscope 2b and the CR apparatus 2c, which have been described in the embodiment of the invention.

Further, in the embodiment of the invention, the photographed image data which have been determined and the patient information correlated thereto are to be stored in the server 4. However, the storing method for storing the photographed image data and the patient information correlated thereto is not limited to this. For example, a system may be configured so that the memory section 33 of the control apparatus 3 can be used as a memory device for storing the photographed image data and the patient information correlated thereto.

Further, in this embodiment, the operation/display section 22 which is a touch screen composed of the display section 221 and touch panel 222 structured integrally is structured so as to serve as a display device and a transmission instruction input device, though the constitution of the display device and transmission instruction input device is not limited to it. For example, it is possible to use a constitution that a display section composed of a CRT (Cathode Ray Tube) or an LCD (Liquid Crystal Display) and an input section composed of a keyboard having a cursor key, numeric character input keys, and various functional keys, and a pointing device such as a mouse are installed separately. Further, in addition to the operation/display section which is a touch screen as indicated in this embodiment, it is possible to use a constitution having an input section composed of a keyboard and a pointing device, wherein the input section functions as a transmission instruction input device.

It is apparent that the present invention is not limited to the above embodiment and various changes and modification may be made.

According to this embodiment, in the small-scale facility, even if the input work of the examination order information is not executed, by a simple operation of selecting the imaging part from the body part icon displayed on the display section when reading an image by the radiographic image reading apparatus, the process according to the imaging part can be performed for the read photographed image, and the processing efficiency and diagnostic efficiency in the small-scale facility can be improved.

According to this embodiment, for the photographed image read by the radiographic image reading apparatus, the image processes including at least one of the ROI extraction process and gradation process can be performed according to the imaging part, so that the image processing efficiency can be improved.

According to this embodiment, when performing the image process for the photographed image read by the radiographic image reading apparatus by an external apparatus, the image process according to the imaging part can be performed efficiently.

According to this embodiment, only by touching one part on the body part icon, the imaging part can be selected simply.

According to this embodiment, the reading apparatus for reading the radiographic image information from the stimulable phosphor plate and generating a photographed image generates reduced image data on the basis of the generated photographed image data and displays the generated reduced image on the display device, so that in the reading apparatus, the imaging operator (imaging engineer or doctor) can judge suitability of the positioning of the patient who is an imaging object. Therefore, the imaging operator can judge earlier necessity of re-imaging and an effect of realizing high efficiency of imaging can be produced.

According to this embodiment, the reduced image is displayed on the display device, so that in the reading apparatus, the imaging operator (imaging engineer or doctor) can judge suitability of the positioning of the patient who is an imaging object. Therefore, the imaging operator can judge earlier necessity of re-imaging and realize high efficiency of imaging.

Further, when photographed image data is transmitted from the reading apparatus to the control apparatus, the transmitted photographed image data and patient information concerning a patient corresponding to the concerned photographed image data are correlated with each other by the correlating device of the control apparatus, so that even if an imaging order is not issued (the examination order information is not inputted) beforehand, an effect of realizing simple correlation of the photographed image with the patient can be produced.

According to this embodiment, the transmission instruction input device is composed of the display device and touch panel, so that there is no need to install separately operation buttons, and the apparatus constitution can be simplified, and a user can operate by observing the contents displayed on the display device, thus an effect of improving the operability can be produced.

What is claimed is:

1. A radiographic image reading apparatus which is used for a small-scale diagnosis system in which radiographing of a patient is conducted by using a cassette containing a stimulable phosphor plate without radiographing order information, and radiographic image of the patient, which is recorded in the stimulable phosphor plate in the cassette, is read by the radiographic image reading apparatus so as to generate a photographed image, and then the generated photographed image is correlated with patient information of the patient, the radiographic image reading apparatus comprising:
a displaying device for displaying a human body part icon indicating respective parts of a human body on a display screen;
a selecting device for selecting and inputting a part corresponding to a photographed part of the patient from the displayed body part icon;
a reading device for reading the radiographic image of the patient, which is recorded in the stimulable phosphor plate in the cassette and obtaining a photographed image; and
a processing device for processing the photographed image read by the reading device based on the part selected by the selecting device.

2. The radiographic image reading apparatus of claim 1,
wherein the processing device performs image processing including at least one of a ROI extraction process and a gradation process for the photographed image according to the part selected by the selecting device.

3. The radiographic image reading apparatus of claim 1,
wherein the processing device performs a process of writing information of the part selected by the selecting device as a supplementary information of the photographed image.

4. The radiographic image reading apparatus of claim 1,
wherein a touch panel is overlaid on the display screen of the displaying device and the selecting device includes the human body part icon displayed on the displaying device and the touch panel.

5. The radiographic image reading apparatus of claim 1 further comprising:
a reduced image generating device for generating reduced image data based on the photographed image data generated by the processing device, and
a reduced image displaying device for displaying a reduced image based on the reduced image data generated by the reduced image generating device.

6. A diagnosis system in which radiographing of a patient is conducted by using a cassette containing a stimulable phosphor plate without radiographing order information, and radiographic image of the patient, which is recorded in the stimulable phosphor plate in the cassette, is read by a radiographic image reading apparatus so as to generate a photographed image, and then the generated photographed image is correlated with patient information of the patient, the diagnosis system comprising,
a radiographic image reading apparatus which is used for a small-scale diagnosis system, the radiographic image reading apparatus including:
a displaying device for displaying a human body part icon indicating respective parts of a human body on a display screen;
a selecting device for selecting and inputting a part corresponding to a photographed part of the patient from the displayed body part icon;
a reading device for reading the radiographic image of the patient, which is recorded in the stimulable phosphor plate in the cassette and obtaining a photographed image; and
a processing device for processing the photographed image read by the reading device based on the part selected by the selecting device,
the diagnosis system further comprising
a control apparatus,
wherein the reading apparatus further comprises:
a transmission instruction input device for inputting a transmission instruction to transmit the photographed image data to the control apparatus; and
a transmitting device for transmitting the photographed image data to the control apparatus according to the transmission instruction from the transmission instruction input device;
wherein the control apparatus comprises:
a receiving device for receiving the photographed image data transmitted by the transmitting device; and
a correlating device for correlating the photographed image data received by the receiving device with patient information of the patient corresponding to the photographed image data.

7. The diagnosis system of claim 6,
wherein a touch panel is overlaid on the display screen of the displaying device and the selecting device includes the human body part icon displayed on the displaying device and the touch panel.
